(19) United States
(12) Patent Application Publication
(10) Pub. No.: US 2025/0363705 A1
(43) Pub. Date: Nov. 27, 2025

(54) METHODS AND SYSTEMS FOR ANIMATING A MODEL IN A VIDEO GAME

(71) Applicant: Sony Interactive Entertainment Inc., Tokyo (JP)

(72) Inventors: Patrick John Connor, London (GB); Graham David Clemo, London (GB)

(21) Appl. No.: 19/213,667

(22) Filed: May 20, 2025

(30) Foreign Application Priority Data
May 21, 2024 (GB) 2407205.0

(51) Int. Cl. G06T 13/40; A63F 13/56

(52) U.S. Cl. CPC G06T 13/40; A63F 13/56

(57) ABSTRACT

A computer-implemented method for animating a model in a video game, the method comprising: obtaining an activity status of the model; obtaining location information of the model, the location information comprising an in-game distance between the model and a viewpoint of the user; selecting, from a database of animations and based on the activity status and the location information, a first animation corresponding to the activity status of the model, the database of animations comprising a plurality of animations corresponding to the activity status of the model, wherein the plurality of animations are different complexity animations; and determining a pose of the model in a scene using the selected first animation. The method prevents unnecessarily complex animations being used and so increases the processing and resource efficiency of animating a model in a video game.

### CROSS REFERENCE TO RELATED APPLICATIONS

The present application claims priority to United Kindgom (GB) Application No. 2407205.0, filed May 21, 2024, the contents of which is incorporated by reference herein in its entirety for all purposes.

### BACKGROUND

Modern video games are often associated with tens of or hundreds of gigabytes of data. This quantity of data typically cannot be stored in a memory device of a video game console running the video game at any one time. This problem is typically solved by dynamically streaming the required data for a current section of the video game being run. The required data is streamed from storage to a memory of the console for the period in which it is needed. However, an issue associated with streaming data is that it introduces latency. This is due to the time it takes between the required data being requested and it being decompressed and copied from storage. The storage may be a storage device of the video game console or cloud storage, for example.

Animation is crucial in many video games because it enhances immersion, bringing characters, objects, and environments to life while providing gameplay feedback, aiding storytelling, and offering gameplay variety. The storage required for animation data in video games can vary depending on factors such as the complexity of the animations, the number of animations, the level of detail, and the compression techniques used. While animation data can contribute to the overall storage footprint of a game, modern compression techniques and optimization strategies help manage storage efficiently. Additionally, streaming techniques may further reduce the storage requirements by loading animations dynamically.

Even with the benefits of compression and streaming techniques, a balance must always be found between quality of animation and the quantity of animation data, and it is desirable to further increase the performance and resource efficiency of animation in video games so that the quality of animation may also be improved.

### SUMMARY

In a first aspect disclosed here, there is provided a computer-implemented method for animating a model in a video game, the method comprising: obtaining an activity status of the model; obtaining location information of the model, the location information comprising an in-game distance between the model and a viewpoint of the user; selecting, from a database of animations and based on the activity status and the location information, a first animation corresponding to the activity status of the model, the database of animations comprising a plurality of animations corresponding to the activity status of the model, wherein the plurality of animations are different complexity animations; and determining a pose of the model in a scene using the selected first animation.

In this method, the term “model” here refers to any visual asset which represents an object or character in the game world. The model may be a 2D or 3D model, and typical examples of models include a player-controlled character, non-player characters (NPC) and objects of scenery such as trees, water, and flags.

As used herein, the complexity of an animation refers to the quality of the resulting animation when a model is animated using the animation, with a higher complexity animation providing a higher quality animation. For example, a higher complexity animation may comprise a larger number of keyframes than a lower complexity animation. In particular, a lower complexity animation there may be no or fewer keyframes for smaller parts of a model such as fingers or eyes. A higher quality animation may comprise a larger number of motion capture points, or bones or instances in a rigged model, than a lower complexity animation. A higher complexity animation may take into account in-game physics to a greater extent when determining the pose and movement of a model. For example, when procedural animation techniques are used, then a higher complexity animation may use a greater quantity of inputs to provide the output.

Therefore, the complexity of an animation also corresponds to the amount of time and/or processing required to obtain the animation and apply it to a model in order to determine the pose of the model in a given scene. While higher complexity animations provide higher quality animations, they also take a greater amount of time and/or processing to provide this animation.

The inventors have recognised that the highest quality animation is not always necessary, and the quality of animation needed to represent movement of a model sufficiently for an observer (i.e. a player of the video game) can be varied to optimise performance. In particular, the inventors have recognised that a player of the video game (i.e. a user) is less likely to notice the difference between higher and lower quality animations at larger distances. For example due to the lower visual fidelity of the distanced model, the lower number of pixels used to represent the model on a display, and/or the lack of player attention on distant models. Therefore, the method of the first aspect introduces a relationship between the complexity of the animation and the distance of the animated model from the viewpoint of the user, thereby preventing unnecessarily complex animations being used and so increasing the processing and resource efficiency of animating a model in a video game.

For the avoidance of doubt, selecting the first animation and using it to determine a pose of the model in a scene also comprises accessing or otherwise obtaining the animation. The exact manner of obtaining the animation will vary depending on how or where the animation is stored. For example, whether the animation is available in local memory or is streamed from remote storage, whether the animation is compressed or is decompressed.

The pose of the model refers to the position and/or the orientation of parts of the model.

The scene is a single snapshot or frame of a virtual environment. The model and the virtual environment may be 2D or 3D.

Selecting the first animation may be further based on the number of pixels used to display the model. This increases the accuracy of the method of the first aspect, helping to ensure an unnecessarily complex animation is not used to determine the pose of the model. This may also take into account the resolution of a display device used to display the video game.

Selecting the first animation may be further based on the quantity of computational resources being used by the video game. In this way, the method further optimises use of computational resources by the video game and helps to avoid throttling. For example, when processing related to foreground models requires utilising a large portion of computational resources then a relatively lower complexity first animation can be selected for animating a model at a large distance from the viewpoint (i.e. a background model). Alternatively, if a computer system running the video game has a large quantity of spare (i.e. unused) computational resources then these may be used to provide a higher quality animation, providing the highest quality animations possible for the user without negatively impacting the game-playing experience.

The plurality of animations may comprise a baseline animation, a middle-distance animation having a higher complexity than the baseline animation, and a close-up animation having a higher complexity than the middle-distance animation.

In this way, the database comprises at least three different complexity animations corresponding to the activity status of the model. The baseline animation may provides the minimum quality level of animation to represent the activity status of the model, while the close-up animation provides the highest quality level of animation to represent the activity status of the model for use when the model is close to the viewpoint of the user.

The database may be stored in remote storage, and the method further comprises streaming the selected first animation from the remote storage. Due to the step of selecting the first animation based on the location information, a minimum quantity of data is streamed from the remote storage and latency issues are reduced. The remote storage may be a server or other storage distinct from the local memory.

The method may further comprise obtaining a second activity status of the model; obtaining second location information of the model, wherein the second location information comprises a second in-game distance between the model and the viewpoint of the user, and the second in-game distance is different to the in-game distance; selecting, from the database of animations and based on the second activity status and second location information, a second animation corresponding to the second activity status of the model, wherein the second animation is a different complexity to the first animation; and determining a second pose of the model in a second scene using the selected second animation.

In this way, the method may update the complexity of the animation as the in-game distance between the model and the viewpoint of the user changes, thereby ensuring the balance is maintained between quality of animation and processing efficiency.

As described above, each additional step in this embodiment may be performed after the first pose is determined. Alternatively, each additional may be performed at a time after the corresponding first version of said step. For example, the second activity status of the model may be obtained at any time after the activity status of the model is obtained, and the second location information of the model may be obtained at any time after the location information of the model is obtained.

The second activity status may be different to the activity status of the model, or may be the same as the activity status of the model.

When the second in-game distance is less than the in-game distance, the second animation may have a higher complexity than the first animation.

When the second in-game distance is greater than the in-game distance, the second animation may have a lower complexity than the first animation.

The method may further comprise: identifying a second model of the same type as the model; obtaining an activity status of the second model; obtaining location information of the second model, the location information of the second model comprising an in-game distance between the second model and the viewpoint of the user; when the following two conditions are met, i) the activity status of the second model is the same as the activity status of the model, and ii) the location information of the second model is similar to the location information of the model: determining a pose of the second model in the scene using the selected first animation.

The type of a model may be provided in information associated with the model, such as metadata of the model. Models having the same type as each other may be appropriately animated using the same animation. Examples of a model type include humanoid, tree, flag, and horse type.

It will be appreciated that the second condition requiring that the location information of the second model is similar to the location information of the model may be defined in various manners. For example, by requiring that the model and the second model are within a threshold distance of each other; such as a distance between the model and the second model being less than or equal to 10% of the distance between the first model and the viewpoint of the user. In another example, by requiring that the in-game distance between the model and the viewpoint of the user is similar to the in-game distance between the second model and the in-game distance; such as the difference between these in-game distances being less than or equal to 10% of the distance between the first model and the viewpoint of the user.

In this way, the method animates a plurality of models in a single scene using a single animation, so does not need to repeat obtaining an animation for each to-be-animated model.

In some embodiments, a third condition must also be met to determine the pose of the second model, the third condition being that the in-game distance between the viewpoint of the user and the model, and the in-game distance between the viewpoint of the user and the second model are each greater than a threshold distance. The threshold distance will depend on the video game, however the models being located greater than a threshold distance from the viewpoint will typically require that the models are part of the background of the scene. This threshold distance may be different to the above threshold distance referring to distance between the model and the second model. A user is more likely to notice a duplicated animation when the animated model is closer to the viewpoint, so introducing this third condition reduces the likelihood of this occurring and detracting from the user experience.

The pose of the model and the pose of the second model may be determined at different frames of the first animation. In this way, it is ensured that the animations of the model and the second model are not synchronised, thereby reducing the likelihood of the user noticing a duplicate animation.

The method may further comprise rendering the scene, wherein the scene comprises the model in the determined pose.

According to a second aspect, there is provided a computer-program comprising instructions which, when executed by one or more processors, cause the processors to perform a method according to the first aspect.

According to a third aspect, there is provided a computer-readable storage medium storing instructions which, when executed by one or more processors, cause the processors to perform a method according to the first aspect.

According to a fourth aspect, there is provided a computer system comprising a memory and one or more processors, the memory storing instructions which, when executed by the one or more processors, cause the processors to perform a method according to the first aspect.

### BRIEF DESCRIPTION OF DRAWINGS

Embodiments of the present disclosure are described below, by way of example only, with reference to the accompanying drawings, in which:

FIG. 1 is a flow diagram of a computer-implemented method in an embodiment of the present disclosure;

FIGS. 2A and 2B schematically illustrate keyframes of example animations in accordance with an embodiment of the present disclosure;

FIGS. 3A and 3B schematically illustrate keyframes of further example animations in accordance with an embodiment of the present disclosure; and

FIG. 4 is a schematic block diagram illustrating a computer system according to an embodiment of the present disclosure.

### DETAILED DESCRIPTION

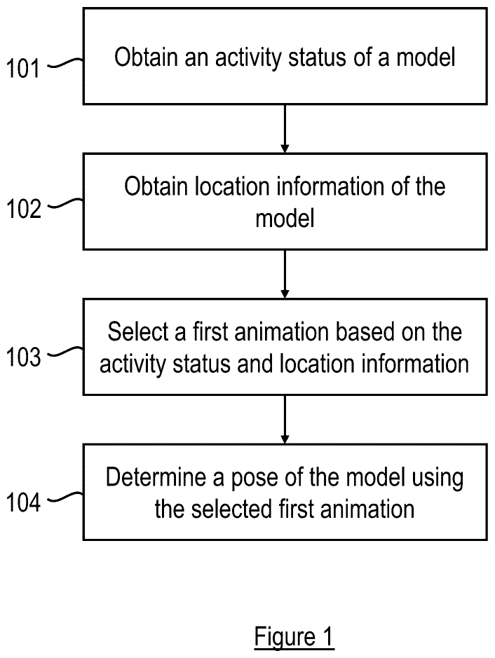

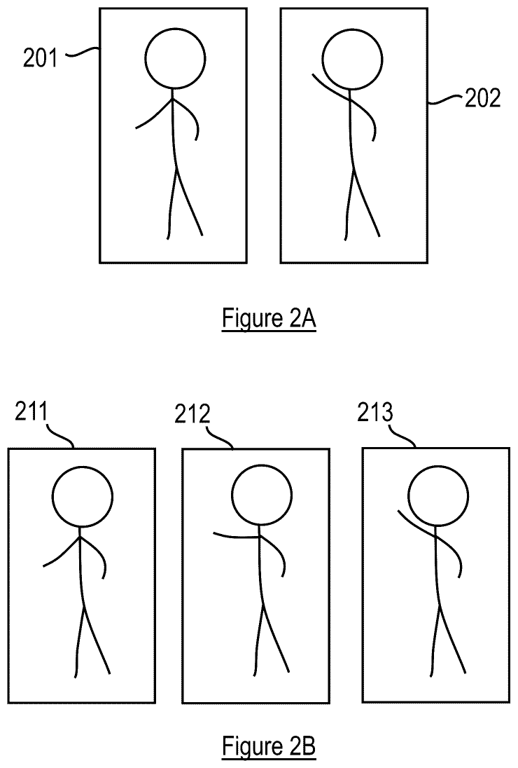

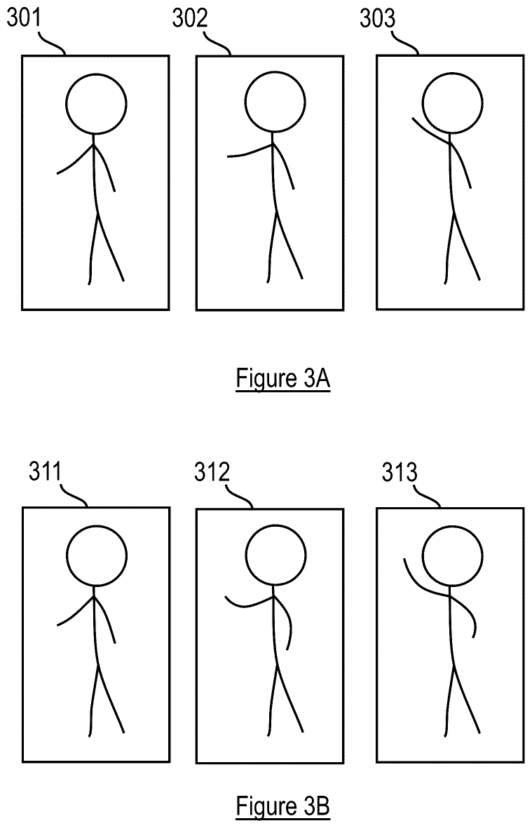

FIG. 1 is a flowchart showing the steps of a computer-implemented method for animating a model in a video game in accordance with an embodiment of the present disclosure. FIGS. 2A, 2B, 3A, and 3B schematically illustrate example keyframes of different animations in accordance with an embodiment of the present disclosure and will be referenced as examples during the following description of the method of FIG. 1.

In a first step 101, an activity status of a model is obtained. In a second step 102, location information of the model is obtained. In a third step 103, a first animation is selected based on the activity status and the location information. In a fourth step 104, a pose of the model is determined using the selected first animation. Although step 101 is shown and described as a first step, and step 102 a second step, this order is not required and step 102 can be performed before or simultaneously to step 101.

In step 101, an activity status of a model is obtained. The activity status may be obtained from metadata of the model, using a marker or flag associated with the model, from game logic controlling the model, by simulating interactions of the model with other nearby entities and the game representation of the model's internal state (such as the emotional or physical state of the object or character it represents), using data sent across a network about other players or the shared state of the game, or using any other suitable means.

An activity status will typically have an associated animation, though this depends on the model. For example, a model representing a person or a tree may have an animation with a small amount of movement even when the model is at rest, while a model representing a building or rock may be immobile when the model is at rest. The model animated in the example animations shown in FIGS. 2A-3B is a stick figure, and the example animations in these figures are each waving animations corresponding to a “waving” activity status of the model.

In step 102, location information of the model is obtained. The location information comprises an in-game distance between the model and a viewpoint of the user. Similarly to the activity status of the model, the location information may be obtained from metadata of the model or game world, from a position defined in a local or world map authored by a game developer, using a marker or flag associated with the model, from game logic controlling the model, by simulating interactions of the model with other nearby entities and the game representation of the model's internal state, using data sent across a network about other players or the shared state of the game, or using any other suitable means.

In step 103, a first animation is selected based on the activity status and the location information. The first animation corresponds to the activity status of the model and is obtained from a database comprising a plurality of animations corresponding to the activity status of the model.

While a plurality of animations in the database may correspond to the same activity status, the plurality of animations may be different complexity animations.

Examples of animations of different complexities which correspond to the same activity status are shown for reference in FIGS. 2A and 2B, and FIGS. 3A and 3B.

FIGS. 2A and 2B each show keyframes of an animation of a stick figure waving. Keyframes are used to define specific points of an animation, with intermediate frames (or in-betweens) being generated between the keyframes to create the illusion of movement. The intermediate frames can be automatically interpolated based on the keyframes in order to avoid manually creating and storing each frame in an animation. Therefore, a greater number of keyframes in an animation provides more control over the animation as a greater number of specific points are defined, but also means there is a greater amount of animation data. The animation in FIG. 2A consists of two keyframes, a first keyframe 201 and a second keyframe 202, and so is a lower complexity animation than the animation in FIG. 2B which consists of three keyframes; a first keyframe 211, a second keyframe 212, and a third keyframe 213. Therefore the lower complexity animation of FIG. 2A may be selected to save computational resources when animating a model which is a large in-game distance from the viewpoint of the user, as the model is too far for the user to notice or be impacted by the lower quality animation relative to the animation of FIG. 2B. Conversely, when the model is close to the viewpoint of the user, a user is likely to have their attention on the model and/or pay more attention to the movement of the model, so it is appropriate to use the higher complexity animation of FIG. 2B rather than the lower complexity animation of FIG. 2A.

FIGS. 3A and 3B each show frames of an animation of a stick figure waving. It is noted that it is irrelevant whether the frames shown in FIGS. 3A and 3B are keyframes or not, the difference in complexity results at least from the movement of the model itself. It will be seen from comparing the first frame 301, second frame 302, and third frame 303 of FIG. 3A to the first frame 311, second frame 312, and third frame 313 of FIG. 3B that the FIG. 3B animation has more points of movement. In particular, the FIG. 3A the stick figure waves through movement at a shoulder joint, while in FIG. 3B the stick figure waves through movement at the shoulder joint and an elbow joint. The FIG. 3B animation is a higher complexity animation due to the greater quantity of points of movement. Therefore the lower complexity animation of FIG. 3A may be selected to save computational resources when animating a model which is a large in-game distance from the viewpoint of the user, as the model is too far for the user to notice or be impacted by the lower quality animation relative to the animation of FIG. 3B. Conversely, when the model is close to the viewpoint of the user, a user is likely to have their attention on the model and/or pay more attention to the movement of the model, so it is appropriate to use the higher complexity animation of FIG. 3B rather than the lower complexity animation of FIG. 3A.

It will be appreciated that the different complexity animations described in relation to FIGS. 2A-3B are examples and that the complexity of animations may vary by virtue of other factors causing different quantities of processing resources to be required to animate a model.

In step 104, a pose of the model in a scene is determined using the selected first animation. The pose of the model refers to the position and/or the orientation of parts of the model. The scene is a snapshot of the game world at a point in time (i.e. a frame), including the model arranged in the game world, for rendering using a graphics pipeline. The precise manner of this determining also depends on the context, for example on what the model represents and/or what format the animation is in. The determined pose of the model may then be used in a graphics pipeline to render the scene.

For example, the scene may be rendered using vertex animation, where the positions of the vertices that make up the polygons of the model are computed according to a technique known as skinning. Typically the model has a skeleton associated with it—this is a set of bones which are represented as a position and orientation. The skinning calculations use the orientation of the bones along with information stored with the polygonal model (blend weights and indices) to calculate the position of each model vertex per frame. The animation is stored as a sequence of changes of orientation of each bone, relative to its base position. This is a function that takes animation time as a parameter and can calculate a position for each bone at every frame. The bone positions can be represented as keyframes, specific points in time where a bone is at an explicit position, combined with blending or interpolating the keyframe information either side at times in-between those keyframe times.

Although the above examples describe only a single animation of a stick figure waving, these are simplified examples and it will be appreciated that a plurality of animations may be combined or blended together as appropriate. For example, the animation of FIG. 3A and another animation of a stick figure walking may be applied to the same model to show the stick figure moving and waving simultaneously.

Where a scene includes a plurality of models, it is possible to animate several of these models using the same animation to save additional computational resources, as different models of the same type can be appropriately animated using the same animation. For example, a scene may include models representing several different trees, where these different trees have the same activity status and have similar location information (e.g. the trees are a similar distance from the viewpoint of the user), it is determined that a single animation can be used to determine a pose of each of the tree models. Preferably, when animating a plurality of models with a single animation, the pose of each model is determined at a different frame of the selected animation to avoid synchronising the movement of the models.

The animation used to determine the pose of the model may also be updated in accordance with changes to the model, such as changes to the activity status of the model and the location information of the model. This ensures the complexity of the animation is kept appropriate for the model, and the balance between quality of animation and processing efficiency is maintained. When the animation is updated, the newer animation may be blended together with the original animation.

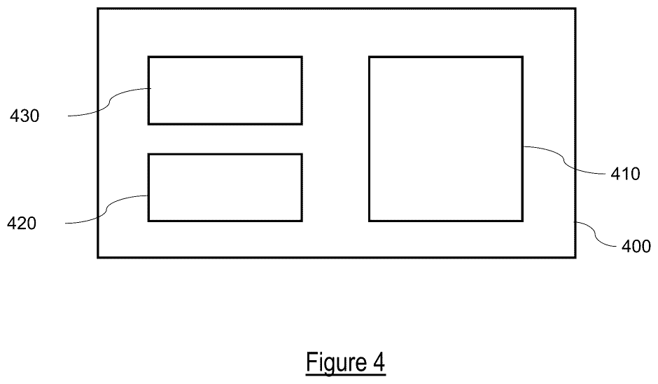

FIG. 4 is a schematic block diagram illustrating a computer system 400 according to an embodiment. The computer system 400 comprises one or more processors 410 configured to perform any of the above-described methods. The processors 410 may be specifically adapted to perform the method (e.g. ASICs) or may be general purpose processors configured to read and execute instructions from a memory 420. The memory 420 may store instructions which, when executed by the one or more processors, cause the processors to perform any of the above-described methods. The computer system 400 may further comprise a memory 430 configured to store a database as described above. In other examples, the database may be separate from the computer system 400.

1. A computer-implemented method for animating a model in a video game, the method comprising:
obtaining an activity status of the model;
obtaining location information of the model, the location information comprising an in-game distance between the model and a viewpoint of a user of the video game;
selecting, from a database of animations and based on the activity status and the location information, a first animation corresponding to the activity status of the model, the database of animations comprising a plurality of animations corresponding to the activity status of the model, wherein the plurality of animations are different complexity animations; and
determining a pose of the model in a scene using the selected first animation.

2. The method of claim 1, wherein selecting the first animation is further based on a resolution used to display the model.

3. The method of claim 1, wherein selecting the first animation is further based on a quantity of computational resources being used by the video game.

4. The method of claim 1, wherein the plurality of animations comprises a baseline animation, a middle-distance animation having a higher complexity than the baseline animation, and a close-up animation having a higher complexity than the middle-distance animation.

5. The method of claim 1, wherein the database is stored in remote storage, and the method further comprises streaming the selected first animation from the remote storage.

6. The method of claim 1, wherein after determining the pose of the model in the scene using the selected first animation, the method further comprises:
obtaining a second activity status of the model;
obtaining second location information of the model, wherein the second location information comprises a second in-game distance between the model and the viewpoint of the user, and the second in-game distance is different to the in-game distance;
selecting, from the database of animations and based on the second activity status and second location information, a second animation corresponding to the activity status of the model, wherein the second animation is a different complexity to the first animation; and
determining a second pose of the model in a second scene using the selected second animation.

7. The method of claim 6, wherein the second activity status is different to the activity status of the model.

8. The method of claim 6, wherein the second activity status is the activity status of the model.

9. The method of claim 6, wherein when the second in-game distance is less than the in-game distance, the second animation has a higher complexity than the first animation.

10. The method of claim 6, wherein when the second in-game distance is greater than the in-game distance, the second animation has a lower complexity than the first animation.

11. The method of claim 1, further comprising:
identifying a second model of a same type as the model;
obtaining an activity status of the second model;
obtaining location information of the second model, the location information of the second model comprising an in-game distance between the second model and the viewpoint of the user;
determining that i) the activity status of the second model is same as the activity status of the model, and ii) the location information of the second model is similar to the location information of the model, and in response,
determining a pose of the second model in the scene using the selected first animation.

12. The method of claim 11, wherein determining the location information of the second model being similar to the location information of the model comprises determining that the in-game distance between the model and the second model is less than or equal to a first threshold distance.

13. The method of claim 12, wherein the first threshold distance is 10% of the in-game distance between the model and the viewpoint of the user.

14. The method of claim 11, wherein the pose of the second model in the scene using the selected first animation is further determined in response to iii) determining that the in-game distance between the viewpoint of the user and the model, and the in-game distance between the viewpoint of the user and the second model are each greater than a second threshold distance.

15. The method of claim 14, wherein the pose of the model and the pose of the second model are determined at different frames of the first animation.

16. The method of claim 1, further comprising rendering the scene, wherein the scene comprises the model in the determined pose.

17. A computer-readable storage medium storing instructions which, when executed by one or more processors, cause the processors to perform operations for animating a model in a video game, the operations comprising:
obtaining an activity status of the model;
obtaining location information of the model, the location information comprising an in-game distance between the model and a viewpoint of a user of the video game;
selecting, from a database of animations and based on the activity status and the location information, a first animation corresponding to the activity status of the model, the database of animations comprising a plurality of animations corresponding to the activity status of the model, wherein the plurality of animations are different complexity animations; and
determining a pose of the model in a scene using the selected first animation.

18. A computer system comprising:
a memory; and
one or more processors,
wherein the memory stores instructions which, when executed by the one or more processors, cause the processors to perform operations for animating a model in a video game, the operations comprising:
obtaining an activity status of the model;
obtaining location information of the model, the location information comprising an in-game distance between the model and a viewpoint of a user of the video game;
selecting, from a database of animations and based on the activity status and the location information, a first animation corresponding to the activity status of the model, the database of animations comprising a plurality of animations corresponding to the activity status of the model, wherein the plurality of animations are different complexity animations; and
determining a pose of the model in a scene using the selected first animation.
